(19) United States
(12) Patent Application Publication
(10) Pub. No.: US 2004/0088498 A1
(43) Pub. Date: May 6, 2004

(54) System and method for preferred memory affinity

(75) Inventors: Jos Manuel Accapadi, Austin, TX (US); Mathew Accapadi, Austin, TX (US); Andrew Dunshea, Austin, TX (US); Dirk Michel, Austin, TX (US)

Correspondence Address: Joseph T. Van Leeuwen, P.O. Box 81641, Austin, TX, 78708-1641, US

(73) Assignee: International Business Machines Corporation, Armonk, NY

(21) Appl. No.: 10/286,532

(22) Filed: Oct. 31, 2002

(51) Int. Cl. G06F 12/00

(52) U.S. Cl. 711/147

(57) ABSTRACT

A system and method for freeing memory from individual pools of memory in response to a threshold being reached that corresponds with the individual memory pools is provided. The collective memory pools form a system wide memory pool that is accessible from multiple processors. When a threshold is reached for an individual memory pool, a page stealer method is performed to free memory from the corresponding memory pool. Remote memory is used to store data if the page stealer is unable to free pages fast enough to accommodate the application's data needs. Memory subsequently freed from the local memory area is once again used to satisfy the memory needs for the application. In one embodiment, memory affinity can be set on an individual application basis so that affinity is maintained between the memory pools local to the processors running the application.

### BACKGROUND OF THE INVENTION

1. Technical Field

The present invention relates in general to a system and method for assigning processors to a preferred memory pool. More particularly, the present invention relates to a system and method for setting thresholds in memory pools that correspond to various processors and cleaning a memory pool when the threshold is reached.

2. Description of the Related Art

Modern computer systems are increasingly complex and often utilize multiple processors and multiple pools of memory. A single computer system may include groups of processors with each of the groups coupled to a high speed bus that allows the processors to read and write data to the memory. Multiple processors allow these computer systems to execute multiple instructions simultaneously. Conversely, a single processor, regardless of its speed, is only able to perform one instruction at a time.

A multiprocessor system is a system in which two or more processors share access to a common random access memory (RAM). Multiprocessor systems include uniform memory access (UMA) systems and non-uniform memory access (NUMA) systems. As the name implies, UMA type multiprocessor systems are designed so that all memory addresses are roughly reachable in the same amount of time, whereas in NUMA systems some memory addresses are reachable faster than other memory addresses. In particular, in NUMA systems “local” memory is reachable faster than “remote” memory even though the entire address space is reachable by any of the processors. Memory that is “local” to one processor (or cluster of processors) is “remote” to another processor (or cluster of processors), and vise versa.

One reason for a given memory pool being faster to reach than another memory pool (in both NUMA systems and other types of multiprocessor systems) is latency that is inherent when reaching data that is further away from a given processor. Because of the distance data needs to travel over data busses to reach a processor, the closer the memory pool is to the processor, the faster the data is reachable by the processor. Another reason that it takes longer to reach remote processors is the protocol, or steps, needed to reach the memory. In a symmetric multiprocessing (SMP) computer system, for example, the data paths and bus protocols used to access remote, rather than local, memory causes the local memory to be reached faster than the remote memory.

Memory affinity algorithms use memory in the local (i.e., fastest reachable) memory pool until it is full, at which point memory is used from remote memory pools. The memory that is accessible by the processors is treated as a system wide pool of memory with pages being freed from the pool (e.g., least recently used (LRU) pages swapped to disk) when the system wide pool becomes full to a certain extent. The challenge of this approach is that if the memory foot print exceeds the free memory available within the local memory pool remote memory will be used. Consequently, system performance is impacted. For example, application programs that use large amounts of data may quickly exhaust memory in the local memory pool before the page stealer method is invoked, forcing the application to store data in remote memory. This degradation may be exacerbated when the application performs significant computational work using the data.

What is needed, therefore, is a system and method that allows an additional level of preferred affinity between a processor and a local memory pool so that pages in the local memory pool can be freed when the local memory pool approaches a full state. Furthermore, what is needed is a system and method that allows the use of remote memory if pages from the local memory pool are not freed at a fast enough pace.

### SUMMARY

It has been discovered that the aforementioned challenges are resolved using a system and method that frees memory from individual pools of memory in response to a threshold being reached that corresponds with the individual memory pools. The collective memory pools form a system wide memory pool that is accessible from multiple processors.

Thresholds may be set for one or more of the individual memory pools. When a threshold is reached, one or more page stealer methods are performed to free least recently used (LRU) pages from the corresponding memory pool. In this manner, an application is able to have more of its data stored in local memory pools, rather than in remote memory.

Free pages in the local memory pool are preferentially used to satisfy memory requests. However, if the page stealer method is unable to free pages fast enough to accommodate the application's data needs, remote memory is used to store the additional data. In this manner, the system and method strive to store data in the local memory pool, but do not block or otherwise hinder the application from continued operation when the local memory pool is full.

In one embodiment, memory affinity can be set on an individual application basis. A preferred memory affinity flag is set for the application indicating that local memory is preferred for the application. If the memory affinity flag is not set, a threshold is not maintained for the individual memory pool. In this manner, some applications that are data intensive, especially those that perform significant computations on the data, can better utilize local memory and garner performance increases without having to use local memory thresholds for all memory pools included in the system.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is a diagram of processor groups being aligned with memory pools interconnected with a high speed bus;

FIG. 2 is a diagram of a memory manager invoking a page stealer method to clean up memory pools in response to the individual memory pools reaching a given threshold;

FIG. 3 is a diagram of a memory manager invoking a page stealer method to clean up memory pools in response to the individual memory pools reaching a given threshold and the pools having their preferred memory affinity flag set;

FIG. 4 is a flowchart showing the initialization of the memory manager and the assignment of processors to preferred memory pools; and

FIG. 5 is a flowchart showing a memory management process invoking the page stealer method in response to various threshold conditions.

### DETAILED DESCRIPTION

The following is intended to provide a detailed description of an example of the invention and should not be taken to be limiting of the invention itself. Rather, any number of variations may fall within the scope of the invention which is defined in the claims following the description.

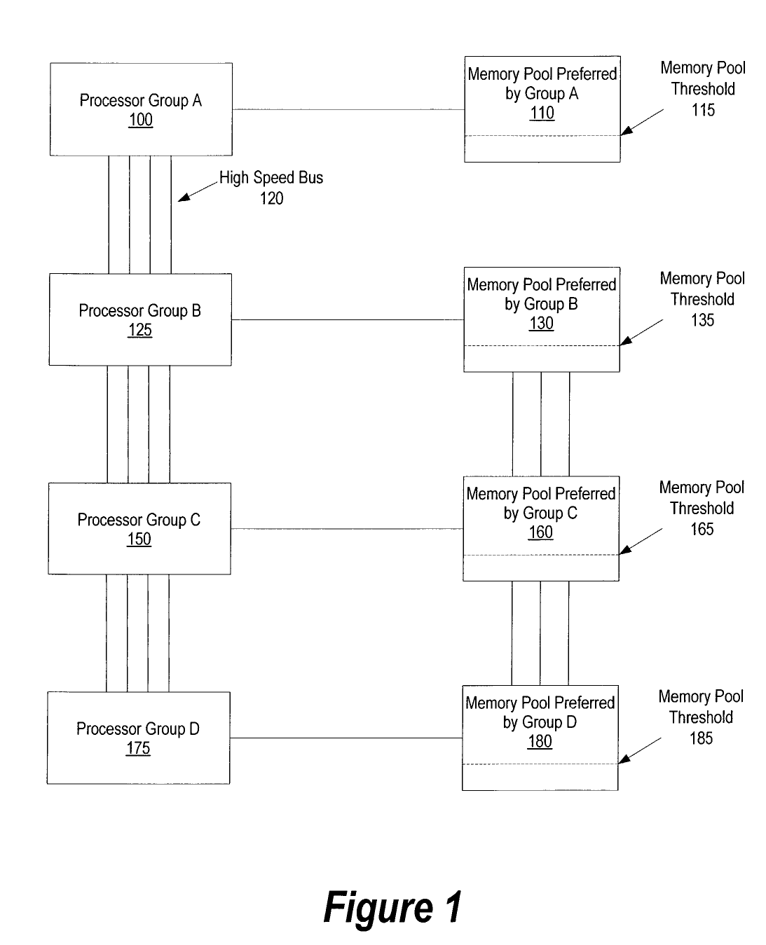

FIG. 1 is a diagram of processor groups being aligned with memory pools interconnected with a high speed bus. Processor group 100 includes one or more processors that access memory pool 110 as their local memory pool. However, if memory pool 110 is full, the processors in group 100 can utilize other memory pools (130, 160, and 180) as remote memory. Data in remote memory is reached by using high speed bus 120 that interconnects the various processors. When preferred local memory affinity is being used for memory pool 110, memory pool threshold 115 is set. When memory pool 110 reaches threshold 115, a page stealer method is used to free space from the memory pool. In this manner, space in memory pool 110 is freed so that applications being executed by processors in group 100 can continue to use the local memory pool 110, rather than using remote memory found in memory pools 130, 160, and 180. However, if the page stealer method is unable to free pages of memory from memory pool 110, processors in processor group 100 are still able to reach and use remote memory. When local memory is subsequently available (having been freed by the page stealer method), processors in group 100 once again preferentially use the memory in memory pool 110 rather than remote memory.

In a similar manner, processor group 125 can preferentially use local memory pool 130. Memory pool threshold 135 can be set for memory pool 130. A page stealer method frees pages of memory from memory pool 130 when threshold 135 is reached. If the process is unable to free memory fast enough, processors in group 125 can still use memory in remote memory pools 110, 160, and 180 using high speed bus 120. Remote memory is used until memory has been freed from memory pool 130, at which time processors in group 125 once again preferentially use the memory located in memory pool 130.

A preferred memory affinity flag can be used for each of the memory pools (110, 130, 160, and 180) so that memory local to a processor group is preferentially used when an application being executed by one of the processors has requested preferential use of local memory. In addition, the memory pool thresholds (115, 135, 165, and 185) set for the various memory pools can be set at different levels within the respective pools or at similar levels. For example, if each memory pool contains 1 gigabyte (1 GB) of memory, threshold 115 can be set when memory group 100 reaches 95% of the available memory, threshold 135 can be set at 90%, threshold 165 can be set at 98%, and threshold 185 can be set at 92%. A threshold that is set closer to the actual size of the memory pool (e.g., 99% of the pool size) increases the probability that applications running in one of the corresponding processors will use remote memory. On the other hand, a threshold that is set further from the actual size of the memory pool (e.g., 80% of the pool size) increases the amount of time spent running the page stealer method but reduces the probability that applications running in corresponding processes will use remote memory.

In another embodiment, preferred memory affinity flags are not used so that local memory is preferentially used as a rule throughout the system. In this embodiment, the threshold levels for the various memory pools can be either the same for each pool or set at different levels (as described above) through configuration settings.

Similar to processor groups 100 and 125, processors in processor groups 150 and 175 have local memory pools (160 and 180, respectively). These local memory pools can be preferentially used by their respective processors. Each memory pool has a memory pool threshold, 165 and 185, respectively. As described above, when memory used in the pools reaches the respective thresholds, a page stealer method is used for each of the pools to free memory. If local memory is not available, remote memory is obtained by utilizing high speed bus 120 until enough local memory is available (i.e., freed by the page stealer method). Remote memory for processor group 150 includes memory pools 110, 130, and 180, while remote memory for processor group 180 includes memory pools 110, 130, and 160.

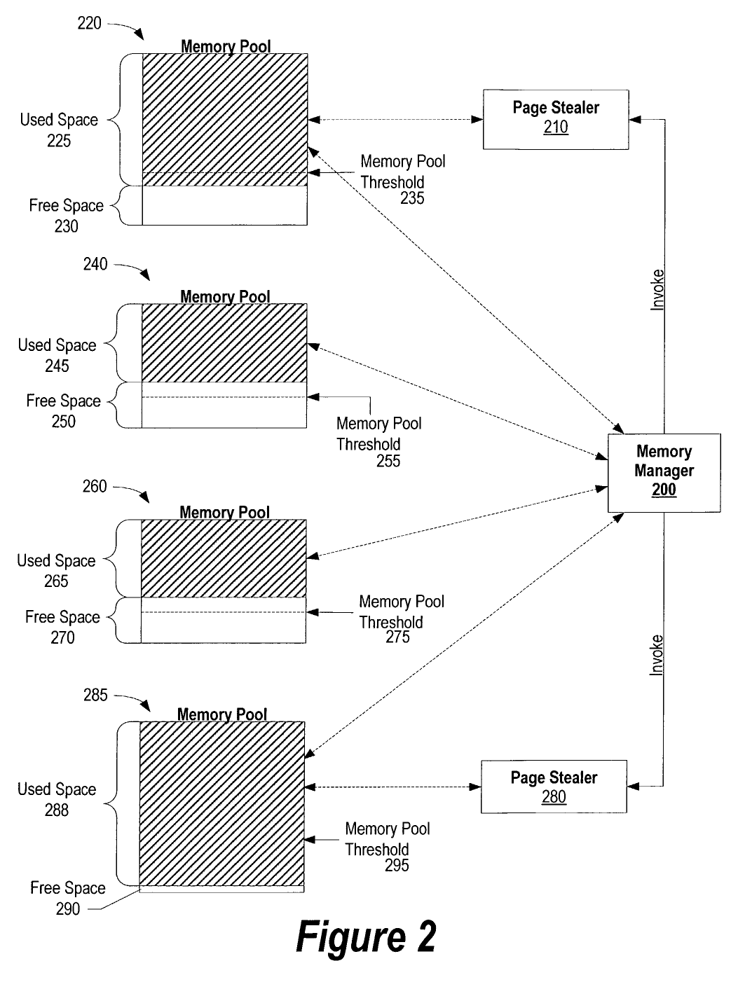

FIG. 2 is a diagram of a memory manager invoking a page stealer method to clean up memory pools in response to the individual memory pools reaching a given threshold. Memory manager 200 is a process that manages memory pools 220, 240, 260, and 285. Each of the memory pools has a memory pool threshold that, when reached, causes the memory manager to invoke a page stealer method to free memory from the corresponding memory pool.

Memory pool 220 is shown with used space 225 and free space 230. In the example shown, the used space in memory pool 220 exceeds threshold 235 that has been set for the memory pool. In response to the threshold being reached, memory manager 200 invokes page stealer method 210 that frees memory from memory pool 220. If a processor that uses memory pool 220 as local memory needs to store data, the memory manager determines whether the data will fit in free space 230. The data is stored in memory pool 220 if the data is smaller than free space 230. Otherwise, the memory manager stores the data in remote memory (memory pool 240, 260, or 285).

Memory pool 240 is shown with used space 245 and free space 250. In the example shown, the used space in memory pool 240 does not exceed threshold 255 that has been set for the memory pool. Therefore, a page stealer method has not been invoked to free space from memory pool 240. If a processor that uses memory pool 240 as local memory needs to store data, the memory manager determines whether the data will fit in free space 250. The data is stored in memory pool 240 if the data is smaller than free space 250. Otherwise, the memory manager stores the data in remote memory (memory pool 220, 260, or 285).

Memory pool 260 is shown with used space 265 and free space 270. In the example shown, the used space in memory pool 260 does not exceed threshold 275 that has been set for the memory pool. Therefore, a page stealer method has not been invoked to free space from memory pool 260. If a processor that uses memory pool 260 as local memory needs to store data, the memory manager determines whether the data will fit in free space 270. The data is stored in memory pool 260 if the data is smaller than free space 270. Otherwise, the memory manager stores the data in a remote memory (memory pool 220, 240, or 285).

Memory pool 285 is shown with used space 288 and free space 290. Like the example shown for memory pool 220, the used space in memory pool 285 exceeds threshold 295 that has been set for the memory pool. In response to the threshold being reached, memory manager 200 invokes page stealer method 280 that frees memory from memory pool 285. If a processor that uses memory pool 285 as local memory needs to store data, the memory manager uses available pages of memory found in free space 290. When these pages have been exhausted, the memory manager uses pages found in remote memory (memory pool 220, 240, or 260). Moreover, as pages of memory are freed by page stealer method 280, these newly available local memory pages are used instead of using remote memory pages.

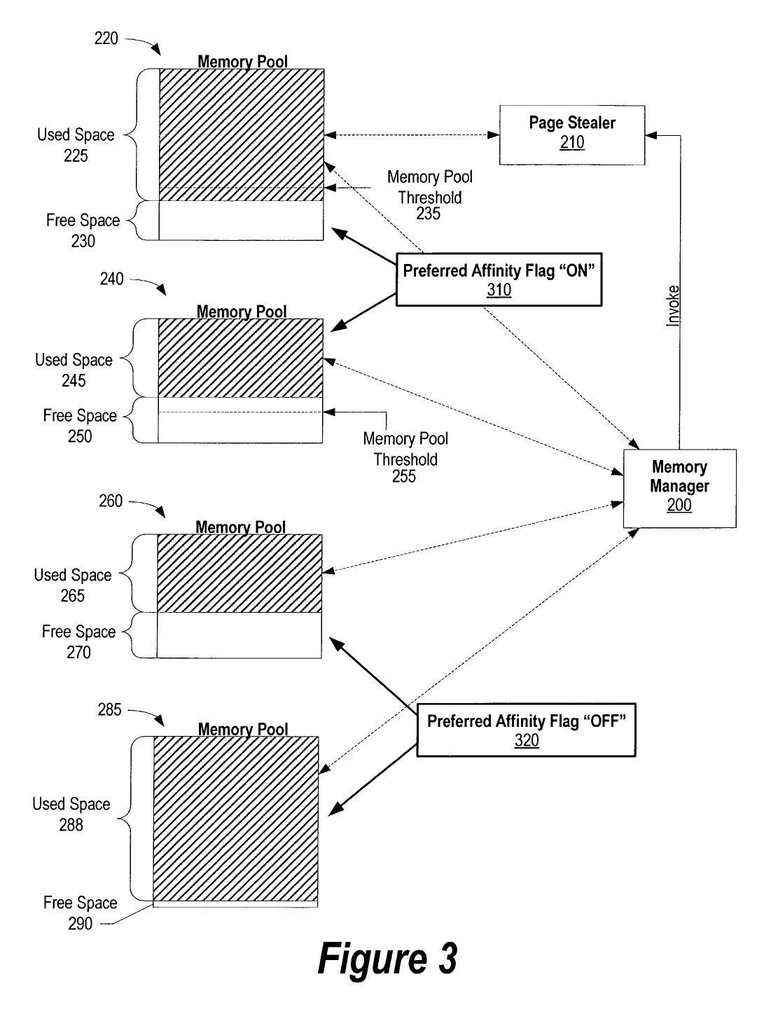

FIG. 3 is a diagram of a memory manager invoking a page stealer method to clean up memory pools in response to the individual memory pools reaching a given threshold and the pools having their preferred memory affinity flag set. This figure is similar to FIG. 2, described above, however FIG. 3 introduces the use of the preferred memory affinity flag.

In the example shown in FIG. 3, preferred memory affinity flag 310 is set “ON” for memory pools 220 and 240. This flag setting indicates that pools 220 and 240 are preferred local memory pools for their corresponding processors. Consequently, memory thresholds 235 and 255 have been set for the respective memory pools. Because the used space in memory pool 220 exceeds threshold 235, page stealer method 210 has been invoked to free space from memory pool 220.

On the other hand, preferred memory affinity flag 320 is set “OFF” for memory pools 260 and 285. This flag setting indicates that pools 260 and 285 do not have individual memory pool thresholds. As a result, a page stealer method has not been invoked to free pages from either memory pool, even though very little free space remains in memory pool 285. Memory is freed from memory pools 260 and 285 when system wide memory utilization reaches a system wide threshold. At that point, one or more page stealer methods are invoked to free pages of memory from all the various memory pools that comprise the system wide memory.

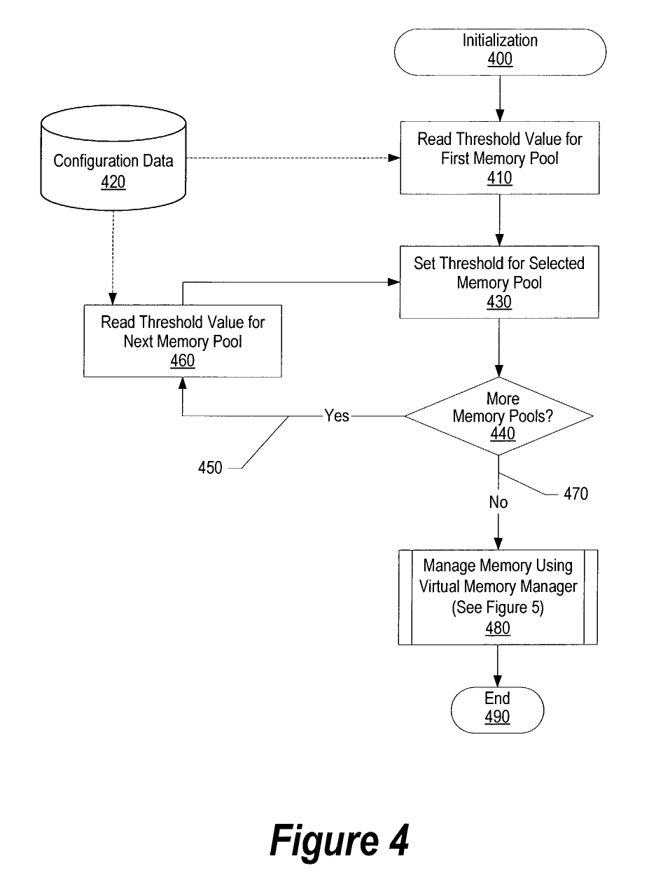

FIG. 4 is a flowchart showing the initialization of the memory manager and the assignment of processors to preferred memory pools. Initialization processing commences at 400 whereupon a threshold value is retrieved for a first memory pool (step 410) from configuration data 420. In one embodiment, threshold values are preset for each memory pool and configuration data 420 are stored in a nonvolatile storage device. In another embodiment, configuration data 420 includes threshold values are requested by applications so that the threshold level can be adjusted, or optimized, for a particular application. The retrieved threshold value is applied to the first memory pool (step 430).

A determination is made as to whether there are more memory pools in the computer system (decision 440). If there are more memory pools, decision 440 branches to “yes” branch 450 which retrieves the configuration value for the next memory pool (step 460) from configuration data 420 and loops back to set the threshold for the memory pool. This looping continues until all thresholds have been set for all memory pools, at which point decision 440 branches to “no” branch 470.

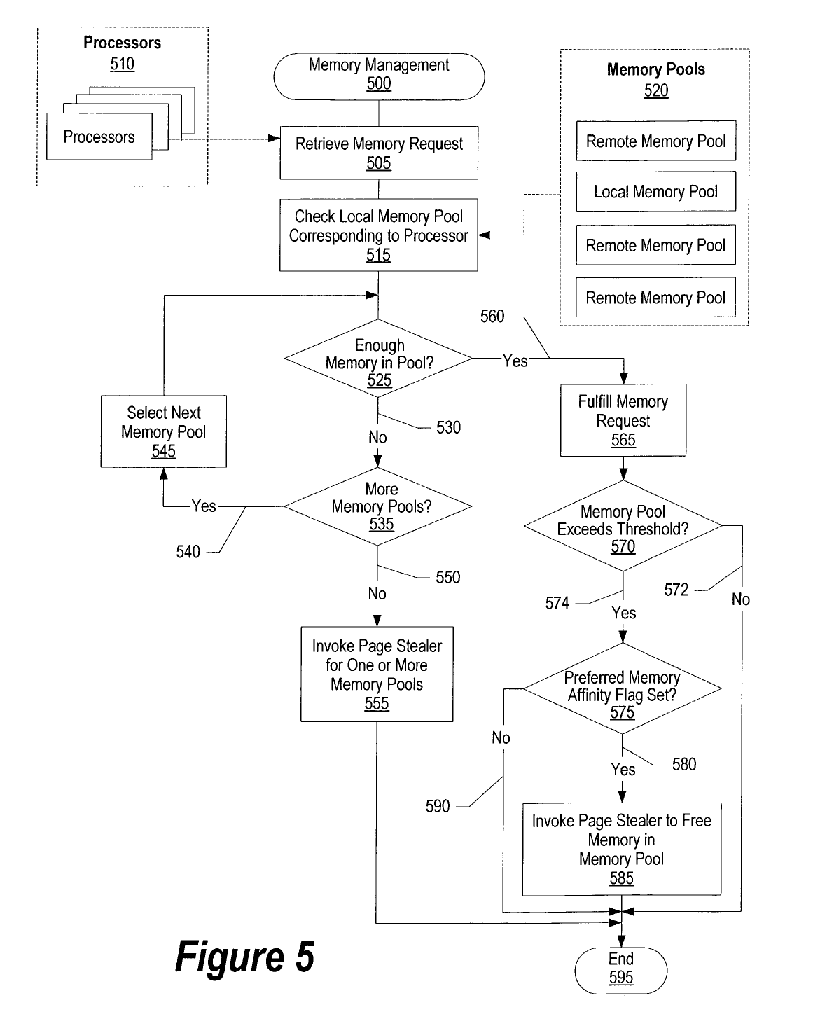

During system operation, memory is managed using a virtual memory manager (predefined process 480, see FIG. 5 and corresponding description for further details). Processing thereafter ends (i.e., system shutdown) at 490.

FIG. 5 is a flowchart showing a memory management process invoking the page stealer method in response to various threshold conditions. Memory management processing commences at 500 whereupon a memory request is received (step 505) from one of the processors included in processors 510.

The local memory pool corresponding to the processor and included in system wide memory pools 520 is checked for available space (step 515). A determination is made as to whether there is enough memory in the local memory pool to satisfy the request (decision 525). If there is not enough memory in the local memory pool, decision 525 branches to “no” branch 530 whereupon another determination is made as to whether there are more memory pools (i.e., remote memory) to check for available space (decision 535). If there are more memory pools, decision 535 branches to “yes” branch 540 whereupon the next memory pool is selected and processing loops back to determine if there is enough space in the remote memory pool. This looping continues until either (i) a memory pool if found with enough available space, or (ii) there are no more memory pools to check. If no memory pool (remote or local) has enough space, decision 535 branches to “no” branch 550 whereupon a page stealer method is invoked to free pages of memory from one or more memory pools (step 555).

On the other hand, if a memory pool (local or remote) is found with enough free memory to satisfy the request, decision 525 branches to “yes” branch 560 whereupon the memory request is fulfilled (step 565). A determination is made after fulfilling the memory request as to whether the used space in the memory pool that was used to fulfill the request exceeds a threshold set for the memory pool (decision 570). If such threshold has not been reached, decision 570 branches to “no” branch 572 and processing ends at 595.

On the other hand, if the threshold has been reached, decision 570 branches to “yes” branch 574 whereupon a determination is made as to whether the preferred memory affinity flag is being used and has been set for the memory pool (decision 575). If the preferred memory affinity flag either (i) is not being used by the system, or (ii) is being used by the system and has been set for the memory pool, decision 575 branches to “yes” branch 580 whereupon a page stealer method is invoked (step 585) in order to free pages of memory from the memory pool. On the other hand, if the preferred memory affinity flag is being used and is not set for the memory pool, decision 575 branches to “no” branch 590 bypassing the invocation of the page stealer. Memory management processing thereafter ends at 595.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method for allocating memory from a local and remote memory pool to an application being executed by a given processor in a computer system, wherein the given processor has at least one of (i) a more direct access path to the local memory pool than to the remote memory pool, and (ii) ownership of the local memory pool and nonownership of the remote memory pool, said method comprising:
enabling the application to store data in the local memory pool until a designated threshold is reached;
freeing memory in the local memory pool in response to the threshold being reached, thereby allowing the application to continue storing data in the local memory pool; and
allowing the application to store data in the remote memory pool if memory is not freed fast enough from the local memory pool to satisfy the memory needs of the application.

2. The method as described in claim 1 further comprising:
continuing the freeing of memory in the local memory pool after the application has been allowed to store data in the remote memory pool.

3. The method as described in claim 1 further comprising:
continuing to enable the application to store data in the local memory pool whenever sufficient free space exists in the local memory pool.

4. The method as described in claim 1 further comprising:
repeating the allowing of the application to store data in the remote memory pool if memory is not freed fast enough from the local memory pool to satisfy the memory needs of the application;
repeatedly continuing the freeing of memory in the local memory pool after the application has been allowed to store data in the remote memory pool; and
continuing to enable the application to store data in the local memory pool whenever sufficient free space exists in the local memory pool.

5. The method as described in claim 1 wherein the freeing of memory is performed by a least recently used page stealing process.

6. The method as described in claim 1 further comprising:
setting a preferred memory affinity flag for one or more applications, wherein the preferred memory affinity flag indicates a preference to utilize memory in the local memory pool.

7. The method as described in claim 6 further comprising:
reading the preferred memory affinity flag from an application control area corresponding to the application, wherein the enabling, freeing and allowing are each performed in response to the determination that the preferred memory affinity flag corresponding to the application has been set.

8. An information handling system comprising:
a plurality of processors;
a plurality of memory pools, each of which is accessible by the processors, wherein each memory pool is a local memory pool to one of the processors and a remote memory pool to the other processors;
a memory management tool to preferentially store data in local memory pools, the memory management tool including:
means for determining which of the processors is running an application;
means for enabling the application to store data in the local memory pool corresponding to the determined processor until a designated threshold is reached;
means for freeing memory in the local memory pool in response to the threshold being reached, thereby allowing the application to continue storing data in the local memory pool; and
means for allowing the application to store data in at least one of the remote memory pools if memory is not freed fast enough from the local memory pool to satisfy the memory needs of the application.

9. The information handling system as described in claim 8 further comprising:
means for continuing the freeing of memory in the local memory pool after the application has been allowed to store data in the remote memory pool.

10. The information handling system as described in claim 8 further comprising:
means for continuing to enable the application to store data in the local memory pool whenever sufficient free space exists in the local memory pool.

11. The information handling system as described in claim 8 further comprising:
means for repeating the allowing of the application to store data in the remote memory pool if memory is not freed fast enough from the local memory pool to satisfy the memory needs of the application;
means for repeatedly continuing the freeing of memory in the local memory pool after the application has been allowed to store data in the remote memory pool; and
means for continuing to enable the application to store data in the local memory pool whenever sufficient free space exists in the local memory pool.

12. The information handling system as described in claim 8 wherein the means for freeing of memory is performed by a least recently used page stealing process.

13. The information handling system as described in claim 8 further comprising:
means for setting a preferred memory affinity flag for one or more applications, wherein the preferred memory affinity flag indicates a preference to utilize memory in the local memory pool; and
means for reading the preferred memory affinity flag from an application control area corresponding to the application, wherein the means for enabling, means for freeing and means for allowing are each performed in response to the determination that the preferred memory affinity flag corresponding to the application has been set.

14. A computer program product stored on a computer operable media for allocating memory from a local and remote memory pool to an application being executed by a given processor in a computer system, wherein the given processor has at least one of (i) a more direct access path to the local memory pool than to the remote memory pool, and (ii) ownership of the local memory pool and nonownership of the remote memory pool, said computer program product comprising:
means for enabling the application to store data in the local memory pool until a designated threshold is reached;
means for freeing memory in the local memory pool in response to the threshold being reached, thereby allowing the application to continue storing data in the local memory pool; and
means for allowing the application to store data in the remote memory pool if memory is not freed fast enough from the local memory pool to satisfy the memory needs of the application.

15. The computer program product as described in claim 14 further comprising:
means for continuing the freeing of memory in the local memory pool after the application has been allowed to store data in the remote memory pool.

16. The computer program product as described in claim 14 further comprising:
means for continuing to enable the application to store data in the local memory pool whenever sufficient free space exists in the local memory pool.

17. The computer program product as described in claim 14 further comprising:
means for repeating the allowing of the application to store data in the remote memory pool if memory is not freed fast enough from the local memory pool to satisfy the memory needs of the application;
means for repeatedly continuing the freeing of memory in the local memory pool after the application has been allowed to store data in the remote memory pool; and
means for continuing to enable the application to store data in the local memory pool whenever sufficient free space exists in the local memory pool.

18. The computer program product as described in claim 14 wherein the means for freeing of memory is performed by a least recently used page stealing process.

19. The computer program product as described in claim 14 further comprising:
means for setting a preferred memory affinity flag for one or more applications, wherein the preferred memory affinity flag indicates a preference to utilize memory in the local memory pool.

20. The computer program product as described in claim 19 further comprising:
means for reading the preferred memory affinity flag from an application control area corresponding to the application, wherein the means for enabling, means for freeing and means for allowing are each performed in response to the determination that the preferred memory affinity flag corresponding to the application has been set.
